(19) United States
(12) Patent Application Publication
(10) Pub. No.: US 2014/0114822 A1
(43) Pub. Date: Apr. 24, 2014

(54) METHOD AND SYSTEM FOR CREATING TAX CONFIGURATION TEMPLATES

(71) Applicant: INTUIT INC., (US)

(72) Inventors: Anil Sharma, Bangalore (IN); Shirish Peshwe, Bangalore (IN); Anshu Verma, Bangalore (IN); Yogish Pai, Mountain View, CA (US); Richard Blitz, Edmonton (CA)

(73) Assignee: INTUIT INC., Mountain View, CA (US)

(21) Appl. No.: 13/655,313

(22) Filed: Oct. 18, 2012

(51) Int. Cl. G06Q 40/00

(52) U.S. Cl. 705/31

(57) ABSTRACT

Individuals implementing/using a financial management system are provided the capability to share their customized and regionally optimized tax configurations with other individuals utilizing the financial management system. The customized and regionally optimized tax configurations are provided to other individuals in the form of tax configuration templates optimized and identified for a given region and/or type of business within the identified region. In various embodiments, the tax configuration templates for a given region can then be viewed, selected, and adopted by other individuals using the financial management system.

### SUMMARY

In accordance with one embodiment, a method and system for creating tax configuration templates provides individuals implementing/using a financial management system, such as a small business financial management system, the capability to share their customized and regionally optimized tax configurations with other individuals utilizing the financial management system. In one embodiment, the customized and regionally optimized tax configurations are provided to other individuals in the form of tax configuration templates, or “tax templates” optimized and identified for a given region and/or type of business within the identified region. In various embodiments, the tax configuration templates for a given region can then be viewed, selected, and adopted by other individuals using the financial management system.

### BRIEF DESCRIPTION OF THE DRAWINGS

FIG. 1 is a block diagram of an exemplary hardware architecture for implementing one embodiment;

FIG. 2A is a process diagram of a process for creating tax configuration templates in accordance with one embodiment;

FIG. 2B shows a tax template database creation process in accordance with one embodiment;

FIG. 2C shows a request and template matching process in accordance with one embodiment; and

FIG. 3 is a flow chart depicting a process for creating tax configuration templates in accordance with one embodiment.

Common reference numerals are used throughout the FIG.s and the detailed description to indicate like elements. One skilled in the art will readily recognize that the above FIG.s are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

In accordance with one embodiment, a system and method for creating tax configuration templates includes a process for creating tax configuration templates implemented by one or more processors associated with one or more computing systems.

As used herein, the term “computing system”, includes, but is not limited to, a desktop computing system; a portable computing system; a mobile computing system; a laptop computing system; a notebook computing system; a tablet computing system; a workstation; a server computing system; a mobile phone; a smart phone; a wireless telephone; a two-way pager; a Personal Digital Assistant (PDA); a media player, i.e., an MP3 player and/or other music and/or video player; an Internet appliance; or any device that includes components that can execute all, or part, of any one of the processes and/or operations as described herein.

In addition, as used herein, the term computing system, can denote, but is not limited to, systems made up of multiple desktop computing systems; portable computing systems; mobile computing systems; laptop computing systems; notebook computing systems; tablet computing systems; workstations; server computing systems; smart phones; wireless telephones; two-way pagers; Personal Digital Assistants (PDAs); media players; Internet appliances; or any devices that can be used to perform the processes and/or operations as described herein.

In one embodiment, one or more computing systems are connected by one or more communications channels, such as, but not limited to: any general network, communications network, or general network/communications network system; a cellular network; a wireless network; a combination of different network types; a public network; a private network; a satellite network; a cable network; or any other network capable of allowing communication between two or more computing systems, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more computing systems, whether available or known at the time of filing or as later developed.

In accordance with one embodiment, the process for creating tax configuration templates is part of, linked to, or otherwise associated with, one or more financial management systems used by one or more of the one or more individuals.

Herein the terms “individual” and “user” are used interchangeably and include, but are not limited to, any individual party and/or entity as discussed herein, and/or as defined in the art at the time of filing, and/or as defined after the time of filing.

Herein the terms “contributing individual” and “contributing user” are used interchangeably and include, but are not limited to, any individual party and/or entity as discussed herein, and/or as defined in the art at the time of filing, and/or as defined after the time of filing, who provides tax template input data representing a customization or change to a tax configuration within a financial management system.

Herein the terms “template seeking individual” and “template seeking user” are used interchangeably and include, but are not limited to, any individual party and/or entity as discussed herein, and/or as defined in the art at the time of filing, and/or as defined after the time of filing, who desires and/or requests a tax configuration template within, or through, a financial management system.

Herein, a financial management system can be, but is not limited to, any data management system implemented on a computing system and/or accessed through a network that processes financial data, including tax configuration data, from one or more sources.

Herein, the term “financial management system” can denote, but is not limited to: computing system implemented, and/or online, personal and/or business financial management systems, packages, programs, modules, or applications; computing system implemented, and/or online, personal and/or business tax preparation systems, packages, programs, modules, or applications; computing system implemented, and/or online, personal and/or business accounting and/or invoicing systems, packages, programs, modules, or applications; and various other personal and/or business electronic data management systems, packages, programs, modules, or applications, whether known at the time of filling or as developed later.

The ability to incorporate, process, implement, and apply, various tax configurations associated with a business is often one of the features that a financial management system offers its users, particularly small business users. However, in order to be effective, the financial management system has to be able to be used in different countries or regions, each having its own tax system, tax rates, and tax rules, i.e., having its own “tax configuration”.

Currently, a financial management system has to be localized for a given region before the financial management system is released in that region, e.g., a region specific version of the financial management system, including a region specific tax configuration, must be created and implemented before the financial management system can be most effectively used in a given region. However, the process of creating numerous region specific versions of a financial management system, including multiple regionalized tax configurations, is a very costly and resource consuming process. Consequently, many financial management systems are never regionally optimized for numerous regions and, if the financial management systems are regionally optimized for a region, the significant cost of localization/optimization is passed on to the user/customer.

In the regions where a regionally optimized version of the financial management systems are not created or available, the individual users must either do without the financial management systems, or at least a regionally optimized tax configuration feature, or spend significant resources essentially localizing the financial management systems, and creating their own regionally optimized tax configurations, individually. As a result, hundreds, or thousands, of individuals in the same region and/or business are currently forced to individually create regionally optimized versions of the financial management system, including regionally optimized tax configurations. Given that these individuals are more often than not creating almost identical individual regionally optimized versions of the financial management systems, and regionally optimized tax configurations, this represents a significant level of redundancy of effort and a huge waste of resources. In short, currently, many individuals in the same region and/or business are forced to each individually “re-invent the wheel” by each individually creating regionally optimized tax configurations that could be used by everyone in the region if there were a mechanism for sharing regionally optimized tax configurations.

Clearly this is a redundant and inefficient process. In addition, even when the financial management systems are regionally optimized for a given region, individual users of financial management systems still often spend considerable time and other resources to individually and independently configure and customize the financial management systems, including tax configurations, to their business activity, and their local tax structure as applied to that activity.

To address this issue, in one embodiment, individuals employing a financial management system, such as a small business financial management system, are provided the capability to share their customized and regionally optimized tax configurations with other individuals utilizing the financial management system.

In one embodiment, once created, the customized and regionally optimized tax configurations within the financial management system are provided to other individuals in the form of “tax configuration templates”, or “tax templates” optimized and identified for a given region and/or type of business within the identified region.

In various embodiments, the tax configuration templates for a given region within the financial management system can be adopted by other “template seeking individuals” as they were submitted by “contributing individuals”, or the tax configuration templates for a given region within the financial management system can be further improved, built upon, or otherwise customized by the template seeking individuals who can then share their contributions/changes as contributing individuals.

In one embodiment, a contributing individual utilizing a financial management system is provided the capability to customize the financial management system for the contributing individual's region, such as a country, state, city, county, zip code, etc., and/or a particular type of business activity within a region, such as retail sales, providing specific services, payroll, production, distribution, etc.

In one embodiment, the contributing individual is provided the capability to customize a tax configuration within the financial management system for the contributing individual's region, such as a country, state, city, county, zip code, etc., and/or a particular type of business activity within a region, such as retail sales, providing specific services, payroll, production, distribution, etc.

In one embodiment, the contributing individual customizes a tax configuration for a region, and/or type of business activity, through a user interface screen provided by the financial management system on a display device of a contributor computing system implementing, or accessing, at least part of the financial management system. In one embodiment, the contributing individual's changes are obtained as tax template input data representing a specific addition or change to a given tax or tax rate applied in the region and/or to the type of business activity. In one embodiment, the contributing individual generates tax template input data representing multiple changes to a tax configuration, or to the entire tax configuration, associated with the region and/or to the type of business activity.

In one embodiment, once the contributing individual generates tax template input data for a region, and/or type of business activity, the tax template input data is used to generate tax template data representing a tax configuration template optimized/customized for the region, and/or type of business activity, that includes the regional optimizations/customization made by the contributing individual.

In one embodiment, once the tax configuration template for a given region is created, at least part of the tax template data is designated as “sharable” by the contributing individual and is provided to the financial management system. In one embodiment, the contributing individual can designate specific tax template data for sharing, or remove tax template data from sharing. For instance, in one embodiment, the contributing individual is provided a tax template data display through which the contributing individual has the option to designate specific portions, and/or specific data fields, of the tax template data for sharing, and/or remove specific portions and/or specific data fields from sharing.

In one embodiment, the contributing individual can opt to share the contributing individual's complete set of tax template data, e.g., share the contributing individual's entire tax configuration template. In other embodiments, the contributing individual can opt to share only data associated with a particular tax agency, such as a designated regional tax, e.g., their local tax agency.

In one embodiment, prior to releasing the contributing individual's tax template data for sharing, the contributing individual is presented a tax configuration template display which lists the tax template data that will be shared. In one embodiment, the tax template data can include, but is not limited to, a list including any of, the tax agencies, agency settings, tax rates, tax rates setting and tax reporting structure that will be shared.

In one embodiment, once approved for sharing by the contributing individual, the tax template data is processed to remove any personal and/or identifying data associated with the contributing individual, e.g., tax registration number, business ID number, social security number, names, etc.

In one embodiment, the contributing individual is asked to provide contributor tax configuration template identification data for the tax template data, such as a name for the tax template data. In one embodiment, the contributor tax configuration template identification data provided is then used to tag the tax template data for later searches as discussed below.

In one embodiment, the tax template data is processed to determine system tax configuration template identification data to be associated with the tax template data. In one embodiment, the system tax configuration template identification data is then used, in one embodiment along with the contributor tax configuration template identification data, to tag the tax template data for later searches as discussed below.

In one embodiment, the contributor tax configuration template identification data and/or system tax configuration template identification data is used to tag and categorize the tax template data according to the region and/or location of the contributing individual and/or the type of business or other activity associated with the contributing individual.

In various embodiments, the contributor tax configuration template identification data and/or system tax configuration template identification data is also used to categorize the tax template data according to various other categorization parameters indicated in the tax template data such as, but not limited to: the type of tax, e.g., sales, side, purchase side, purchase reclaimable; the tax agencies involved, e.g., the agency name, filling frequency, financial year, reporting standard; the various tax rates, e.g., sale/purchase, percent rate, calculated on net amount or tax on tax region, location, type of business, tax type etc.

As an illustrative example, if the contributing individual is located in Frankfurt, Germany, the tax configuration template is automatically tagged with Germany and Frankfurt. In one embodiment, the contributing individual can modify and/or then edit the applied identification data.

In one embodiment, once the tax template data is tagged and/or categorized, the tax template data is stored/added to a tax template database associated with the financial management system.

In one embodiment, the tax template database associated with the financial management system includes all tax template data submitted by contributing individuals from one or more tax regions.

As used herein, the term “database” includes, but is not limited to, any data storage mechanism known at the time of filing, or as developed thereafter, such as, but not limited to, a hard drive or memory; a designated server system or computing system, or a designated portion of one or more server systems or computing systems; a server system network; a distributed database; or an external and/or portable hard drive. Herein, the term “database” can refer to a dedicated mass storage device implemented in software, hardware, or a combination of hardware and software. Herein, the term “database” can refer to a web-based function. Herein, the term “database” can refer to any data storage means that is part of, or under the control of, any computing system, as discussed herein, known at the time of filing, or as developed thereafter.

In one embodiment, when a template seeking individual using the financial management system desires to implement a tax configuration optimized for their region, and/or business type, within the financial management system, the template seeking individual provides tax template request data.

In one embodiment, the tax template request data includes data indicating the template seeking individual's desired search parameters, such as, but not limited to, any one or more of, the tax region; the type of tax, e.g., sales, side, purchase side, purchase reclaimable; the tax agencies involved, e.g., the agency name, filling frequency, financial year, reporting standard; the various tax rates, e.g., sale/purchase, percent rate, calculated on net amount or tax on tax; the business type, etc.

In one embodiment, the tax template database is then searched for a tax configuration template matching, or most closely matching, the entered search parameters of the tax template request data. In one embodiment, one or more matched tax configuration templates, as represented by tax template data, matching, or most closely matching, the entered search parameters of the tax template request data are identified.

In one embodiment, tax template data representing the one or more matched tax configuration templates is then provided to the template seeking individual for review. In one embodiment the template seeking individual then selects a tax configuration template, matching, or most closely matching, the template seeking individual's needs.

In one embodiment, the selected tax configuration template is then imported to the template seeking individual's template seeking computing system where the matched tax template data is used to configure the template seeking individual's financial management system implementation in accordance with the selected matched tax configuration template.

In one embodiment, template seeking individuals are provided the capability to rate the provided tax template data and, in one embodiment, one or more forms of compensation are provided to the contributing individuals who are the creators of tax configuration templates that are widely used, and/or are highly rated.

As a specific illustrative example of the operation of one embodiment, assume a contributing individual user of a financial management system sets up a company and customizes the financial management system tax configuration for the contributing individual's region and/or type of business.

In this specific illustrative example, assume the contributing individual decides to share the contributing individual's tax template data with other individuals using the financial management system. In this specific illustrative example, the contributing individual is provided the capability to share the contributing individual's tax configuration through a website associated with the financial management system.

In this illustrative example, the contributing individual's tax template data is scrubbed of any identifying and/or personal data and the contributing individual is provided the opportunity to designate parts of the contributing individual's tax template data as sharable or non-sharable.

In this illustrative example, the resulting contributing individual's tax configuration template is then classified according to region and business type and stored as a tax configuration template accessible through the website.

In this specific example, a template seeking individual user of the financial management system is provided access to the website associated with the financial management system and the tax configuration templates from multiple contributing individuals. In this specific example, an initial search is conducted of the available tax configuration templates using one or more search parameters included in tax template request data provided by the template seeking individual.

In this example, the template seeking individual then reviews the details of the matched tax configuration templates identified and provided as “results” of the search and selects a matched tax configuration template which most closely matches the template seeking individual's needs.

The template seeking individual then imports the selected matched tax configuration template and the localized tax configuration is setup within the financial management system without the template seeking individual having to enter the local/regional operational and/or statutory details of the regional tax configuration.

As another specific illustrative example of the operation of one embodiment, the provider of the financial management system contacts accountants who are familiar with the tax regulations for various tax regions and asks the accountants to create a regionally optimized tax configuration templates for the tax regions. Thus, in this specific illustrative example, the accountants are the contributing individuals.

In this illustrative example, the accountant created tax configuration templates are then classified according to region and business type and stored as tax configuration templates accessible through a website.

In this specific example, a template seeking individual user of the financial management system can then access the website associated with the financial management system and browse through the available tax configuration templates. The template seeking individual then goes through the details of the tax configurations represented by the available tax configuration templates and finds a tax configuration template which most closely matches the template seeking individual's needs.

In this example, the template seeking individual then selects and imports the matched tax configuration template into the template seeking individual's system and the regionally optimized tax configuration is setup without the template seeking individual having to enter the operational and/or statutory details.

Using the system and method for creating tax configuration templates discussed herein, the tax configuration of a financial management system is optimized for a specific region and/or business type by individual users of the financial management system and the resulting tax configuration templates are shared through a tax template database. Consequently, using the system and method for creating tax configuration templates discussed herein, region specific versions of tax configuration used with financial management systems are created in an efficient and resource conserving manner.

### Hardware System Architecture

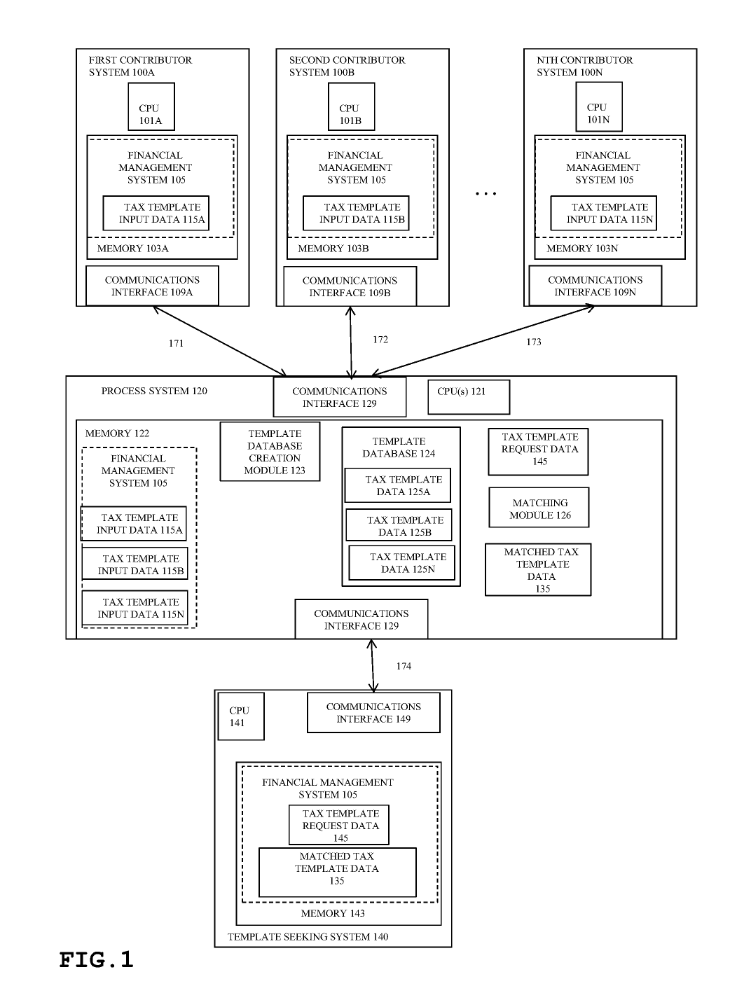

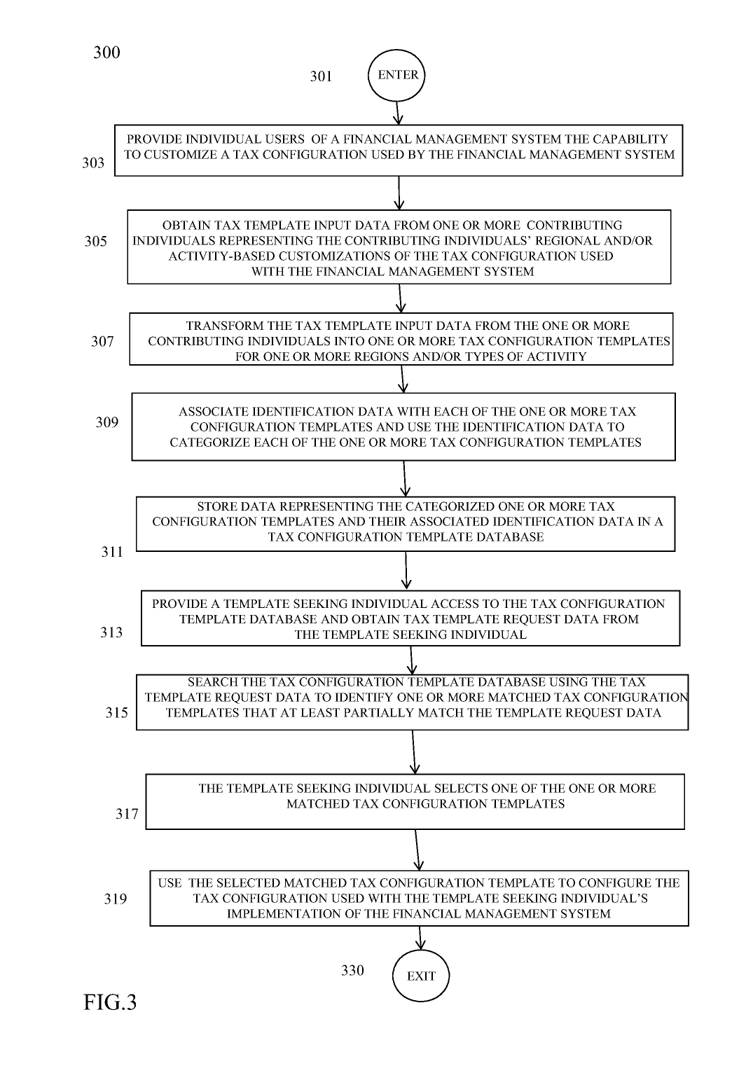

FIG. 1 is a block diagram of an exemplary hardware architecture for implementing one embodiment of a process for creating tax configuration templates, such as exemplary process 300 (FIG. 3) discussed herein.

FIG. 1 includes contributor systems 100A, 100B, through 100N, e.g., “N” representative computing systems associated with “N” contributing individuals who provide tax template data 115A, 115B, through 115N; process system 120, e.g., a computing system associated with a provider of a process for creating tax configuration templates; a representative template seeking system 140, e.g., a computing system associated with a template seeking individual searching template database 124 for matched tax template data 135 using tax template request data 145; and communication channels 171, 172, 173, and 174.

As seen in FIG. 1, contributor systems 100A, 100B, through 100N include processor/Central Processing Units (CPUs) 101A, 101B, through 101N, memories 103A, 103B, through 103N, and communication interfaces 109A, 109B, through 109N.

In some embodiments, memories 103A, 103B, through 103N include all or part of financial management system 105. In various embodiments, financial management system 105 is any financial management system as discussed herein, and/or as known/available in the art at the time of filing, and/or as developed/made available after the time of filing. In one embodiment, financial management system 105 is a computing system implemented small business financial management system.

In some embodiments, memories 103A, 103B, through 103N include all or part of tax template input data 115A, 115B, through 115N. As discussed below, the contributing individuals associated with contributor systems 100A, 100B, through 100N utilizing financial management system 105 are provided the capability to customize and optimize a tax configuration used by financial management system 105 for the contributing individual's region, such as a country, state, city, county, zip code, etc., and/or a particular type of business activity within a region, such as retail sales, providing specific services, payroll, production, distribution, etc. In one embodiment, these regional customizations and optimizations result in the generation of tax template input data 115A, 115B, through 115N.

In one embodiment, tax template input data 115A, 115B, through 115 is then provided to process system 120 through financial management system 105, communications interfaces 109A, 109B, through 109N, communications channels 171, 172, and 173, and communications interface 129.

Contributor systems 100A, 100B, through 100N, as shown in FIG. 1, are representative of any number “N” computing systems associated with one or more individuals. As discussed herein tax template input data 115A, 115B, through 115N in FIG. 1, can be obtained from a large number of individuals, even as many as thousands or hundreds of thousands or millions of individuals. Consequently, in various embodiments, Contributor systems 100A, 100B, through 100N can be representative of hundreds of thousands, or even millions, of contributor systems and/or tax template input data 115A, 115B, through 115N can be representative tax template input data received from hundreds of thousands, or even millions, of individuals. Consequently, the three representative contributor systems 100A, 100B, through 100N are shown in FIG. 1 for illustrative purposes and are not limiting to the claims presented below.

In various embodiments, contributor systems 100A, 100B, through 100N can be any computing system discussed herein, and/or as known in the art at the time of filing, and/or as developed after the time of filing.

In various embodiments, contributor systems 100A, 100B, through 100N may further include standard interface devices such as a keyboard (not shown), a mouse (not shown), a printer (not shown), as well as, one or more standard input/output (I/O) devices (not shown), such as a compact disk (CD) or Digital Video Disc (DVD) drive, floppy disk drive, or other digital or waveform port, or other device capable of inputting data to, and outputting data from, contributor systems 100A, 100B, through 100N, whether available or known at the time of filing or as later developed.

Process system 120 can be any computing system as discussed herein, and/or as known in the art at the time of filing, and/or as developed thereafter, that includes components that can execute all, or part, of a process for creating tax configuration templates in accordance with at least one of the embodiments as described herein.

In one embodiment, process system 120 includes one or more Central Processing Units (CPUs) 121, memory 122, and communications interface 129.

In one embodiment, memory 122 includes all, or part, of financial management system 105. In some embodiments, financial management system 105 is any financial management system as discussed herein, and/or as known/available in the art at the time of filing, and/or as developed/made available after the time of filing. In one embodiment, financial management system 105 is a web-based, or server implemented small business financial management system.

In one embodiment, memory 122 includes all, or part, of tax template input data 115A, 115B, through 115N received from contributor systems 100A, 100B, through 100N, and through financial management system 105.

In one embodiment, memory 122 includes all, or part, of template database creation module 123 used to transform at least part of tax template input data 115A, 115B, through 115N into categorized tax template data 125A, 125B, through 125N stored in tax template database 124.

In one embodiment, memory 122 includes all, or part, of tax request data 145. As discussed below, in one embodiment, tax request data 145 is received from template seeking system 140 via financial management system 105, communications interface 149, communications channel 174, and communications interface 129.

As discussed below, in one embodiment, a tax template seeking individual associated with template seeking system 140 obtains access to tax template database 124 and provides tax template request data 145 to indicate a desire to implement a tax configuration optimized for their region, and/or business type, and to provide desired tax template search parameters. In one embodiment, tax template request data 145 includes data indicating the template seeking individual's desired search parameters, such as, but not limited to, any one or more of, the tax region; the type of tax, e.g., sales, side, purchase side, purchase reclaimable; the tax agencies involved, e.g., the agency name, filling frequency, financial year, reporting standard; the various tax rates, e.g., sale/purchase, percent rate, calculated on net amount or tax on tax; the business type, etc.

In one embodiment, matching module 126 uses tax template request data 145 to search template database 124. In one embodiment tax template database 124 is searched for one or more tax configuration templates, e.g., tax configuration templates represented by tax template data 125A, 125B, through 125N matching, or most closely matching, the entered search parameters of tax template request data 145.

In one embodiment, the template seeking individual then selects a tax configuration template, represented by matched tax template data 135 in FIG. 1, matching, or most closely matching, the template seeking individual's needs.

Process system 120 may further include standard interface devices such as a keyboard (not shown), a mouse (not shown), a printer (not shown), as well as, one or more standard input/output (I/O) devices (not shown), such as a compact disk (CD) or Digital Video Disc (DVD) drive, floppy disk drive, or other digital or waveform port, or other device capable of inputting data to, and outputting data from, process system 120, whether available or known at the time of filing or as later developed.

Template seeking system 140 can be any computing system as discussed herein, and/or as known in the art at the time of filing, and/or as developed thereafter, that includes components that can execute all, or part, of a process for creating tax configuration templates in accordance with at least one of the embodiments as described herein.

In one embodiment, template seeking system 140 includes one or more Central Processing Units (CPUs) 141, memory 143, and communications interface 149.

In one embodiment, memory 143 includes all, or part, of financial management system 105. In some embodiments, financial management system 105 is any financial management system as discussed herein, and/or as known/available in the art at the time of filing, and/or as developed/made available after the time of filing. In one embodiment, financial management system 105 is a computing system implemented, or web-based, and/or server implemented small business financial management system.

In one embodiment, memory 143 includes tax template request data 145 as provided to process system 120 and matched tax template data 135 as received from process system 120 via communications interface 129, communications channel 174, and communications interface 149.

Tax template seeking system 140 may further include standard interface devices such as a keyboard (not shown), a mouse (not shown), a printer (not shown), as well as, one or more standard input/output (I/O) devices (not shown), such as a compact disk (CD) or Digital Video Disc (DVD) drive, floppy disk drive, or other digital or waveform port, or other device capable of inputting data to, and outputting data from, process system 120, whether available or known at the time of filing or as later developed.

In one embodiment, any, or all, of communications channels 171, 172, 173, and 174 can be, but are not limited to: any network; a mobile communication link, such as a mobile phone link; a land-line phone link; a cable-based communications channel; a satellite communications channel; the Internet, a cloud, or other network communications channel; and/or any other communications channel, or combination of communications channels, as discussed herein, and/or as known in the art at the time of filing, and/or as developed after the time of filing.

In one embodiment, contributor systems 100A, 100B, through 100N, provider system 120, and/or template seeking system 140 are part of a cloud computing environment.

Those of skill in the art will readily recognize that the components shown in FIG. 1, and their respective sub-components, are shown for illustrative purposes only and that architectures with more or fewer components can implement, and benefit from, the invention. In addition, the particular type of, and configuration of, contributor systems 100A, 100B, through 100N, provider system 120, and/or template seeking system 140 are not relevant.

In various embodiments, the elements shown in FIG. 1 are grouped into one or more processes, or sub-processes, used to implement all, or part of, a process for creating tax configuration templates, such as exemplary process 300 (FIG. 3) discussed herein.

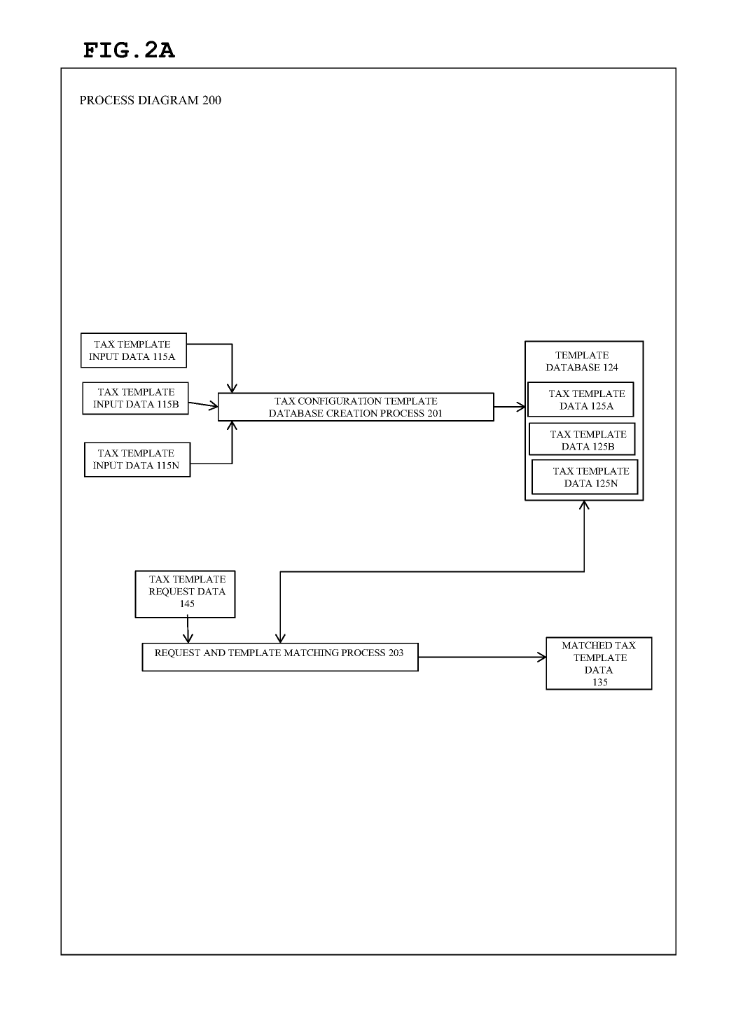

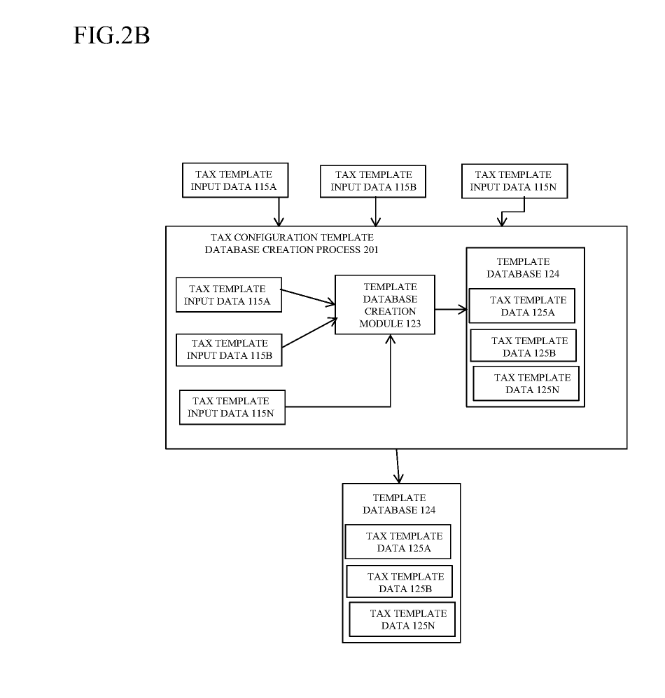

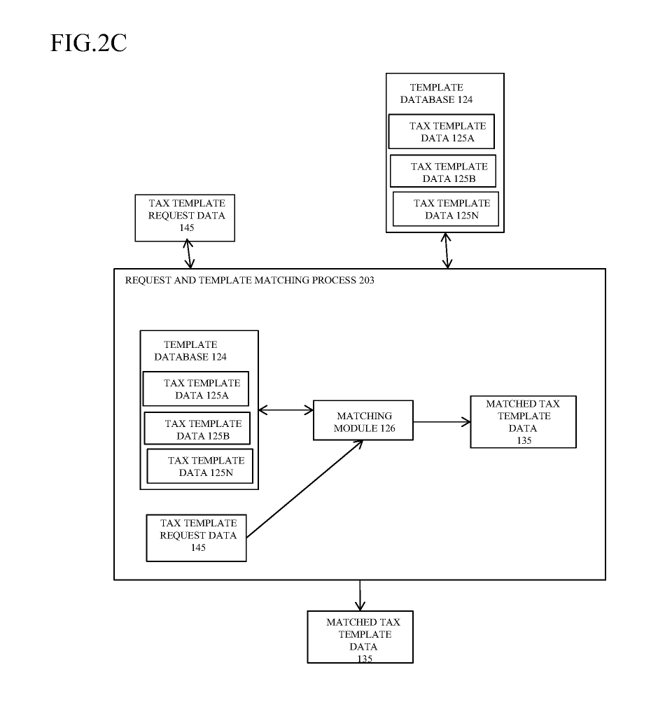

FIG. 2A is a process diagram showing one illustrative example of the interaction of various illustrative processes, or sub-processes, 201 and 203 used to implement all, or part of, a process for creating tax configuration templates, such as exemplary process 300 (FIG. 3) discussed herein.

FIGS. 2B and 2C show illustrative examples of processes 201 and 203 in accordance with one embodiment.

Referring to FIG. 1, FIG. 2A, FIG. 2B, and FIG. 2C together, tax template input data 115A, 115B, through 115N are provided to tax configuration template creation process 201 where tax template input data 115A, 115B, through 115N is transformed to generate template database 124 including categorized tax template data 125A, 125B, through 125N. FIG. 2B shows tax configuration template creation process 201 in more detail.

As seen in FIG. 2B, tax template input data 115A, 115B, through 115N is used as input data to template database creation module 123 that processes tax template input data 115A, 115B, through 115N to generate tax template data 125A, 125B, through 125N stored in template database 124.

In one embodiment, template database creation module 123 transforms tax template input data 115A, 115B, through 115N into categorized tax template data 125A, 125B, through 125N by processing tax template input data 115A, 115B, through 115N to remove any personal and/or identifying data associated with the contributing individuals, e.g., tax registration number, business ID number, social security number, names, etc.

In one embodiment, template database creation module 123 transforms tax template input data 115A, 115B, through 115N into categorized tax template data 125A, 125B, through 125N by tagging and/or categorizing tax template input data 115A, 115B, through 115N.

In one embodiment, the contributing individuals are asked to provide contributor tax configuration template identification data for tax template input data 115A, 115B, through 115N such as a name for the tax template data.

In one embodiment, tax template input data 115A, 115B, through 115N is processed to determine system tax configuration template identification data to be associated with the tax template data.

In one embodiment, template database creation module 123 uses the contributor tax configuration template identification data and/or system tax configuration template identification data to tag and categorize tax template input data 115A, 115B, through 115N according to the region and/or location of the contributing individual and/or the type of business or other activity associated with the contributing individual; thereby generating categorized tax template data 125A, 125B, through 125N.

In various embodiments, template database creation module 123 uses the contributor tax configuration template identification data and/or system tax configuration template identification data to categorize tax template input data 115A, 115B, through 115N according to various other categorization parameters indicated in the tax template data such as, but not limited to: the type of tax, e.g., sales, side, purchase side, purchase reclaimable; the tax agencies involved, e.g., the agency name, filling frequency, financial year, reporting standard; the various tax rates, e.g., sale/purchase, percent rate, calculated on net amount or tax on tax region, location, type of business, tax type etc.

In one embodiment, the tagged, identified, and/or categorized tax template data 125A, 125B, through 125N is then stored/added to tax template database 124.

In one embodiment, tax template database 124 includes all tax template data submitted by contributing individuals from one or more tax regions.

Referring back to FIG. 1, FIG. 2A, FIG. 2B, and FIG. 2C together, in one embodiment, tax template request data 145 is provided to request and template matching process 203 which uses tax template request data 145 to search and retrieve matched tax template data 135 from template database 124. Request and template matching process 203 is shown in more detail in FIG. 2C.

Referring to FIG. 2C, tax template request data 145 is used as input data for matching module 126. In one embodiment, tax template request data 145 includes data indicating the template seeking individual's desired search parameters, such as, but not limited to, any one or more of, the tax region; the type of tax, e.g., sales, side, purchase side, purchase reclaimable; the tax agencies involved, e.g., the agency name, filling frequency, financial year, reporting standard; the various tax rates, e.g., sale/purchase, percent rate, calculated on net amount or tax on tax; the business type, etc.

In one embodiment, matching module 126 uses the entered search parameters of tax template request data 145 to search tax template database 124 for tax configuration templates, represented by categorized tax template data 125A, 125B, through 125N matching, or most closely matching, the entered search parameters of tax template request data 145.

In one embodiment, one or more matched tax configuration templates matching, or most closely matching, the entered search parameters of tax template request data 145 are identified by matching module 126.

In one embodiment, tax template data representing the one or more matched tax configuration templates is then provided to the template seeking individual for review.

In one embodiment, the template seeking individual selects a tax configuration template of the one or more the tax configuration templates matching, or most closely matching, the template seeking individual's needs, represented by matched tax template data 135 in FIG. 2C.

In one embodiment, matched tax template data 135 is then imported to the template seeking individual's template seeking computing system where matched tax template data 135 is used to configure the template seeking individual's financial management system implementation in accordance with matched tax template data 135.

In the discussion above, certain aspects of one embodiment include processes, sub-processes, steps, operations and/or instructions described herein for illustrative purposes in a particular order and/or grouping. However, the particular order and/or grouping shown and discussed herein are illustrative only and not limiting. Those of skill in the art will recognize that other orders and/or grouping of the processes, sub-processes, steps, operations and/or instructions are possible and, in some embodiments, one or more of the processes, sub-processes, steps, operations and/or instructions discussed above can be combined and/or deleted. In addition, portions of one or more of the processes, sub-processes, steps, operations and/or instructions can be re-grouped as portions of one or more other of processes, sub-processes, steps, operations and/or instructions discussed herein. Consequently, the particular order and/or grouping of the processes, sub-processes, steps, operations and/or instructions discussed herein do not limit the scope of the invention as claimed below.

### Process

In accordance with one embodiment, a method and system for creating tax configuration templates provides individuals implementing/using a financial management system, such as a small business financial management system, the capability to share their customized and regionally optimized tax configurations with other individuals utilizing the financial management system. In one embodiment, the customized and regionally optimized tax configurations are provided to other individuals in the form of tax configuration templates, or “tax templates” optimized and identified for a given region and/or type of business within the identified region. In various embodiments, the tax configuration templates for a given region can then be viewed, selected, and adopted by other individuals using the financial management system.

FIG. 3 is a flow chart depicting a process 300 for creating tax configuration templates in accordance with one embodiment. Process 300 for creating tax configuration templates begins at ENTER OPERATION 301 of FIG. 3 and process flow proceeds to PROVIDE INDIVIDUAL USERS OF A FINANCIAL MANAGEMENT SYSTEM THE CAPABILITY TO CUSTOMIZE A TAX CONFIGURATION USED BY THE FINANCIAL MANAGEMENT SYSTEM OPERATION 303.

In one embodiment, at PROVIDE INDIVIDUAL USERS OF A FINANCIAL MANAGEMENT SYSTEM THE CAPABILITY TO CUSTOMIZE A TAX CONFIGURATION USED BY THE FINANCIAL MANAGEMENT SYSTEM OPERATION 303 a financial management system is provided that allows individuals, e.g., users of the financial management system, the capability to modify and customize features of the financial management system, including the tax configuration used by the financial management system.

In accordance with one embodiment, process 300 for creating tax configuration templates is part of, linked to, or otherwise associated with, one or more financial management systems used by one or more of one or more individuals.

Herein the terms “individual” and “user” are used interchangeably and include, but are not limited to, any individual party and/or entity as discussed herein, and/or as defined in the art at the time of filing, and/or as defined after the time of filing.

Herein the terms “contributing individual” and “contributing user” are used interchangeably and include, but are not limited to, any individual party and/or entity as discussed herein, and/or as defined in the art at the time of filing, and/or as defined after the time of filing, who provides tax template input data representing a customization or change to a tax configuration within a financial management system.

Herein the terms “template seeking individual” and “template seeking user” are used interchangeably and include, but are not limited to, any individual party and/or entity as discussed herein, and/or as defined in the art at the time of filing, and/or as defined after the time of filing, who desires and/or requests a tax configuration template within, or through, a financial management system.

Herein, a financial management system can be, but is not limited to, any data management system implemented on a computing system and/or accessed through a network that processes financial data, including tax configuration data, from one or more sources.

Herein, the term “financial management system” can denote, but is not limited to: computing system implemented, and/or online, personal and/or business financial management systems, packages, programs, modules, or applications; computing system implemented, and/or online, personal and/or business tax preparation systems, packages, programs, modules, or applications; computing system implemented, and/or online, personal and/or business accounting and/or invoicing systems, packages, programs, modules, or applications; and various other personal and/or business electronic data management systems, packages, programs, modules, or applications, whether known at the time of filling or as developed later.

The ability to incorporate, process, implement, and apply, various taxes associated with a business is often one of the features that a financial management system offers its users, particularly small business users. However, in order to be effective, the financial management system has to be able to be used in different countries or regions, each having its own tax system, tax rates, and tax rules, i.e., having its own “tax configuration”.

Currently, a financial management system has to be localized for a given region before the financial management system is released in that region, e.g., a region specific version of the financial management system, including a region specific tax configuration must be created and implemented before the financial management system can be most effectively used in a given region. However, the process of creating numerous region specific versions of a financial management system, including multiple tax configurations, is a very costly and resource consuming process. Consequently, many financial management systems are never regionally optimized for numerous regions and, if the financial management systems are regionally optimized for a region, the significant cost of localization/optimization is passed on to the user/customer.

In the regions where a regionally optimized version of the financial management systems are not created or available, the individual users must either do without the financial management systems, or at least a regionally optimized tax configuration feature, or spend significant resources essentially localizing the financial management systems, and creating their own regionally optimized tax configurations, individually. As a result, hundreds, or thousands, of individuals in the same region and/or business are currently forced to individually create regionally optimized versions of the financial management system, including regionally optimized tax configurations. Given that these individuals are more often than not creating almost identical individual regionally optimized versions of the financial management systems, and regionally optimized tax configurations, this represents a significant level of redundancy of effort and a huge waste of resources. In short, currently, many individuals in the same region and/or business are forced to each individually “re-invent the wheel” by each individually creating regionally optimized tax configurations that could be used by everyone in the region if there were a mechanism for sharing regionally optimized tax configurations.

Clearly this is a redundant and inefficient process. In addition, even when the financial management systems are regionally optimized for a given region, individual users of financial management systems still often spend considerable time and other resources to individually and independently configure and customize the financial management systems, including tax configurations, to their business activity, and their local tax structure as applied to that activity.

As discussed below, to address this issue, in one embodiment, individuals employing a given financial management system, such as a small business financial management system, are provided the capability to share their customized and regionally optimized tax configurations with other individuals utilizing the financial management system.

In one embodiment, at PROVIDE INDIVIDUAL USERS OF A FINANCIAL MANAGEMENT SYSTEM THE CAPABILITY TO CUSTOMIZE A TAX CONFIGURATION USED BY THE FINANCIAL MANAGEMENT SYSTEM OPERATION 303 individuals utilizing a financial management system are provided the capability to customize the financial management system for the contributing individual's region, such as a country, state, city, county, zip code, etc., and/or a particular type of business activity within a region, such as retail sales, providing specific services, payroll, production, distribution, etc.

In one embodiment, at PROVIDE INDIVIDUAL USERS OF A FINANCIAL MANAGEMENT SYSTEM THE CAPABILITY TO CUSTOMIZE A TAX CONFIGURATION USED BY THE FINANCIAL MANAGEMENT SYSTEM OPERATION 303 individuals are provided the capability to customize a tax configuration within the financial management system for the contributing individual's region, such as a country, state, city, county, zip code, etc., and/or a particular type of business activity within a region, such as retail sales, providing specific services, payroll, production, distribution, etc.

In one embodiment, once a financial management system is provided that allows individuals, e.g., users of the financial management system, the capability to modify and customize features of the financial management system, including the tax configuration used by the financial management system, at PROVIDE INDIVIDUAL USERS OF A FINANCIAL MANAGEMENT SYSTEM THE CAPABILITY TO CUSTOMIZE A TAX CONFIGURATION USED BY THE FINANCIAL MANAGEMENT SYSTEM OPERATION 303, process flow proceeds to OBTAIN TAX TEMPLATE INPUT DATA FROM ONE OR MORE CONTRIBUTING INDIVIDUALS REPRESENTING THE CONTRIBUTING INDIVIDUALS' REGIONAL AND/OR ACTIVITY-BASED CUSTOMIZATIONS OF THE TAX CONFIGURATION USED WITH THE FINANCIAL MANAGEMENT SYSTEM OPERATION 305.

In one embodiment, at OBTAIN TAX TEMPLATE INPUT DATA FROM ONE OR MORE CONTRIBUTING INDIVIDUALS REPRESENTING THE CONTRIBUTING INDIVIDUALS' REGIONAL AND/OR ACTIVITY-BASED CUSTOMIZATIONS OF THE TAX CONFIGURATION USED WITH THE FINANCIAL MANAGEMENT SYSTEM OPERATION 305, one or more contributing individuals optimize or customize one of more tax configurations used with the financial management system of PROVIDE INDIVIDUAL USERS OF A FINANCIAL MANAGEMENT SYSTEM THE CAPABILITY TO CUSTOMIZE A TAX CONFIGURATION USED BY THE FINANCIAL MANAGEMENT SYSTEM OPERATION 303 to generate tax template input data.

In one embodiment, at OBTAIN TAX TEMPLATE INPUT DATA FROM ONE OR MORE CONTRIBUTING INDIVIDUALS REPRESENTING THE CONTRIBUTING INDIVIDUALS' REGIONAL AND/OR ACTIVITY-BASED CUSTOMIZATIONS OF THE TAX CONFIGURATION USED WITH THE FINANCIAL MANAGEMENT SYSTEM OPERATION 305 the contributing individuals customize tax configurations for a region, and/or type of business activity, through user interface screens provided by the financial management system on a display device of contributor computing systems implementing, or accessing, at least part of the financial management system.

In one embodiment, at OBTAIN TAX TEMPLATE INPUT DATA FROM ONE OR MORE CONTRIBUTING INDIVIDUALS REPRESENTING THE CONTRIBUTING INDIVIDUALS' REGIONAL AND/OR ACTIVITY-BASED CUSTOMIZATIONS OF THE TAX CONFIGURATION USED WITH THE FINANCIAL MANAGEMENT SYSTEM OPERATION 305 the contributing individuals' changes are obtained as tax template input data representing specific additions or changes to a given tax or tax rate applied their regions and/or to the types of business activity.

In one embodiment, at OBTAIN TAX TEMPLATE INPUT DATA FROM ONE OR MORE CONTRIBUTING INDIVIDUALS REPRESENTING THE CONTRIBUTING INDIVIDUALS' REGIONAL AND/OR ACTIVITY-BASED CUSTOMIZATIONS OF THE TAX CONFIGURATION USED WITH THE FINANCIAL MANAGEMENT SYSTEM OPERATION 305 the contributing individuals generate tax template input data representing multiple changes to the tax configurations, or to the entire tax configurations, associated with their regions and/or to the types of business activity.

In one embodiment, at OBTAIN TAX TEMPLATE INPUT DATA FROM ONE OR MORE CONTRIBUTING INDIVIDUALS REPRESENTING THE CONTRIBUTING INDIVIDUALS' REGIONAL AND/OR ACTIVITY-BASED CUSTOMIZATIONS OF THE TAX CONFIGURATION USED WITH THE FINANCIAL MANAGEMENT SYSTEM OPERATION 305 the contributing individuals' tax template input data is obtained from contributor computing systems, such as any computing system discussed herein, and/or as known in the art/available at the time of filing, and/or as developed/made available after the time of filing.

In one embodiment, at OBTAIN TAX TEMPLATE INPUT DATA FROM ONE OR MORE CONTRIBUTING INDIVIDUALS REPRESENTING THE CONTRIBUTING INDIVIDUALS' REGIONAL AND/OR ACTIVITY-BASED CUSTOMIZATIONS OF THE TAX CONFIGURATION USED WITH THE FINANCIAL MANAGEMENT SYSTEM OPERATION 305 the contributing individuals' tax template input data is obtained via one or more means for transferring data such as, but not limited to, providing the data through one or more network locations; e-mail; text message; POTS; or any other method, means, mechanism, process or procedure for transferring data discussed herein, and/or as known/available in the art at the time of filing, and/or as developed/made available after the time of filing.

In one embodiment, once one or more contributing individuals optimize or customize one of more tax configurations used with the financial management system of PROVIDE INDIVIDUAL USERS OF A FINANCIAL MANAGEMENT SYSTEM THE CAPABILITY TO CUSTOMIZE A TAX CONFIGURATION USED BY THE FINANCIAL MANAGEMENT SYSTEM OPERATION 303 to generate tax template input data at OBTAIN TAX TEMPLATE INPUT DATA FROM ONE OR MORE CONTRIBUTING INDIVIDUALS REPRESENTING THE CONTRIBUTING INDIVIDUALS' REGIONAL AND/OR ACTIVITY-BASED CUSTOMIZATIONS OF THE TAX CONFIGURATION USED WITH THE FINANCIAL MANAGEMENT SYSTEM OPERATION 305, process flow proceeds to TRANSFORM THE TAX TEMPLATE INPUT DATA FROM THE ONE OR MORE CONTRIBUTING INDIVIDUALS INTO ONE OR MORE TAX CONFIGURATION TEMPLATES FOR ONE OR MORE REGIONS AND/OR TYPES OF ACTIVITY OPERATION 307.

In one embodiment, at TRANSFORM THE TAX TEMPLATE INPUT DATA FROM THE ONE OR MORE CONTRIBUTING INDIVIDUALS INTO ONE OR MORE TAX CONFIGURATION TEMPLATES FOR ONE OR MORE REGIONS AND/OR TYPES OF ACTIVITY OPERATION 307, the contributing individuals' generated tax template input data is transformed and used to generate tax template data representing one or more tax configuration templates optimized/customized for one or more regions, and/or types of business activity, that includes the regional optimizations/customizations made by the contributing individuals at OBTAIN TAX TEMPLATE INPUT DATA FROM ONE OR MORE CONTRIBUTING INDIVIDUALS REPRESENTING THE CONTRIBUTING INDIVIDUALS' REGIONAL AND/OR ACTIVITY-BASED CUSTOMIZATIONS OF THE TAX CONFIGURATION USED WITH THE FINANCIAL MANAGEMENT SYSTEM OPERATION 305.

In one embodiment, at TRANSFORM THE TAX TEMPLATE INPUT DATA FROM THE ONE OR MORE CONTRIBUTING INDIVIDUALS INTO ONE OR MORE TAX CONFIGURATION TEMPLATES FOR ONE OR MORE REGIONS AND/OR TYPES OF ACTIVITY OPERATION 307 at least part of the tax template data is designated as “sharable” by the contributing individuals and is provided to the financial management system.

In one embodiment, at TRANSFORM THE TAX TEMPLATE INPUT DATA FROM THE ONE OR MORE CONTRIBUTING INDIVIDUALS INTO ONE OR MORE TAX CONFIGURATION TEMPLATES FOR ONE OR MORE REGIONS AND/OR TYPES OF ACTIVITY OPERATION 307 the contributing individuals can designate specific tax template data for sharing, or remove tax template data from sharing.

For instance, in one embodiment, at TRANSFORM THE TAX TEMPLATE INPUT DATA FROM THE ONE OR MORE CONTRIBUTING INDIVIDUALS INTO ONE OR MORE TAX CONFIGURATION TEMPLATES FOR ONE OR MORE REGIONS AND/OR TYPES OF ACTIVITY OPERATION 307 the contributing individuals are provided a tax template data displays through which the contributing individuals have the option to designate specific portions, and/or specific data fields, of the tax template data for sharing, and/or remove specific portions and/or specific data fields from sharing.

In one embodiment, at TRANSFORM THE TAX TEMPLATE INPUT DATA FROM THE ONE OR MORE CONTRIBUTING INDIVIDUALS INTO ONE OR MORE TAX CONFIGURATION TEMPLATES FOR ONE OR MORE REGIONS AND/OR TYPES OF ACTIVITY OPERATION 307 the contributing individuals can opt to share their complete set of tax template data, e.g., share the contributing individuals' entire tax configuration templates. In other embodiments, the contributing individuals can opt to share only data associated with a particular tax agency, such as a designated regional tax, e.g., their local tax agency.

In one embodiment, prior to releasing the contributing individual's tax template data for sharing, at TRANSFORM THE TAX TEMPLATE INPUT DATA FROM THE ONE OR MORE CONTRIBUTING INDIVIDUALS INTO ONE OR MORE TAX CONFIGURATION TEMPLATES FOR ONE OR MORE REGIONS AND/OR TYPES OF ACTIVITY OPERATION 307 the contributing individuals are presented tax configuration template displays which list the tax template data that will be shared. In one embodiment, the tax template data can include, but is not limited to, a list including any of, the tax agencies, agency settings, tax rates, tax rates setting and tax reporting structure that will be shared.

In one embodiment, once approved for sharing by the contributing individuals, the tax template data is processed at TRANSFORM THE TAX TEMPLATE INPUT DATA FROM THE ONE OR MORE CONTRIBUTING INDIVIDUALS INTO ONE OR MORE TAX CONFIGURATION TEMPLATES FOR ONE OR MORE REGIONS AND/OR TYPES OF ACTIVITY OPERATION 307 to remove any personal and/or identifying data associated with the contributing individuals, e.g., tax registration number, business ID number, social security number, names, etc.

In one embodiment, once the contributing individuals' generated tax template input data is transformed and used to generate tax template data representing one or more tax configuration templates optimized/customized for one or more regions, and/or types of business activity, that includes the regional optimizations/customizations made by the contributing individuals process flow proceeds to ASSOCIATE IDENTIFICATION DATA WITH EACH OF THE ONE OR MORE TAX CONFIGURATION TEMPLATES AND USE THE IDENTIFICATION DATA TO CATEGORIZE EACH OF THE ONE OR MORE TAX CONFIGURATION TEMPLATES OPERATION 309.

In one embodiment, at ASSOCIATE IDENTIFICATION DATA WITH EACH OF THE ONE OR MORE TAX CONFIGURATION TEMPLATES AND USE THE IDENTIFICATION DATA TO CATEGORIZE EACH OF THE ONE OR MORE TAX CONFIGURATION TEMPLATES OPERATION 309, the tax template data of TRANSFORM THE TAX TEMPLATE INPUT DATA FROM THE ONE OR MORE CONTRIBUTING INDIVIDUALS INTO ONE OR MORE TAX CONFIGURATION TEMPLATES FOR ONE OR MORE REGIONS AND/OR TYPES OF ACTIVITY OPERATION 307 is tagged and/or categorized.

In one embodiment, at ASSOCIATE IDENTIFICATION DATA WITH EACH OF THE ONE OR MORE TAX CONFIGURATION TEMPLATES AND USE THE IDENTIFICATION DATA TO CATEGORIZE EACH OF THE ONE OR MORE TAX CONFIGURATION TEMPLATES OPERATION 309 the contributing individuals are asked to provide contributor tax configuration template identification data for the tax template data of TRANSFORM THE TAX TEMPLATE INPUT DATA FROM THE ONE OR MORE CONTRIBUTING INDIVIDUALS INTO ONE OR MORE TAX CONFIGURATION TEMPLATES FOR ONE OR MORE REGIONS AND/OR TYPES OF ACTIVITY OPERATION 307, such as a name for the tax template data. In one embodiment, the contributor tax configuration template identification data provided is then used to tag the tax template data for later searches as discussed below.

In one embodiment, at ASSOCIATE IDENTIFICATION DATA WITH EACH OF THE ONE OR MORE TAX CONFIGURATION TEMPLATES AND USE THE IDENTIFICATION DATA TO CATEGORIZE EACH OF THE ONE OR MORE TAX CONFIGURATION TEMPLATES OPERATION 309 the tax template data of TRANSFORM THE TAX TEMPLATE INPUT DATA FROM THE ONE OR MORE CONTRIBUTING INDIVIDUALS INTO ONE OR MORE TAX CONFIGURATION TEMPLATES FOR ONE OR MORE REGIONS AND/OR TYPES OF ACTIVITY OPERATION 307 is processed to determine system tax configuration template identification data to be associated with the tax template data.

In one embodiment, the system tax configuration template identification data is then used, in one embodiment along with the contributor tax configuration template identification data, to tag the tax template data for later searches as discussed below.

In one embodiment, at ASSOCIATE IDENTIFICATION DATA WITH EACH OF THE ONE OR MORE TAX CONFIGURATION TEMPLATES AND USE THE IDENTIFICATION DATA TO CATEGORIZE EACH OF THE ONE OR MORE TAX CONFIGURATION TEMPLATES OPERATION 309 the tax template data of TRANSFORM THE TAX TEMPLATE INPUT DATA FROM THE ONE OR MORE CONTRIBUTING INDIVIDUALS INTO ONE OR MORE TAX CONFIGURATION TEMPLATES FOR ONE OR MORE REGIONS AND/OR TYPES OF ACTIVITY OPERATION 307 is processed to determine system tax configuration template identification data to be associated with the tax template data under the direction of one or more processors, such as CPU 121 of FIG. 1, associated with one or more computing systems, such as process system 120 of FIG. 1.

Returning to FIG. 3, in one embodiment, at ASSOCIATE IDENTIFICATION DATA WITH EACH OF THE ONE OR MORE TAX CONFIGURATION TEMPLATES AND USE THE IDENTIFICATION DATA TO CATEGORIZE EACH OF THE ONE OR MORE TAX CONFIGURATION TEMPLATES OPERATION 309 the contributor tax configuration template identification data and/or system tax configuration template identification data is used to tag and categorize the tax template data according to the region and/or location of the contributing individual and/or the type of business or other activity associated with the contributing individual.

In various embodiments, at ASSOCIATE IDENTIFICATION DATA WITH EACH OF THE ONE OR MORE TAX CONFIGURATION TEMPLATES AND USE THE IDENTIFICATION DATA TO CATEGORIZE EACH OF THE ONE OR MORE TAX CONFIGURATION TEMPLATES OPERATION 309 the contributor tax configuration template identification data and/or system tax configuration template identification data is also used to categorize the tax template data according to various other categorization parameters indicated in the tax template data such as, but not limited to: the type of tax, e.g., sales, side, purchase side, purchase reclaimable; the tax agencies involved, e.g., the agency name, filling frequency, financial year, reporting standard; the various tax rates, e.g., sale/purchase, percent rate, calculated on net amount or tax on tax region, location, type of business, tax type etc.

In one embodiment, once the tax template data of TRANSFORM THE TAX TEMPLATE INPUT DATA FROM THE ONE OR MORE CONTRIBUTING INDIVIDUALS INTO ONE OR MORE TAX CONFIGURATION TEMPLATES FOR ONE OR MORE REGIONS AND/OR TYPES OF ACTIVITY OPERATION 307 is tagged and/or categorized at ASSOCIATE IDENTIFICATION DATA WITH EACH OF THE ONE OR MORE TAX CONFIGURATION TEMPLATES AND USE THE IDENTIFICATION DATA TO CATEGORIZE EACH OF THE ONE OR MORE TAX CONFIGURATION TEMPLATES OPERATION 309, process flow proceeds to STORE DATA REPRESENTING THE CATEGORIZED ONE OR MORE TAX CONFIGURATION TEMPLATES AND THEIR ASSOCIATED IDENTIFICATION DATA IN A TAX CONFIGURATION TEMPLATE DATABASE OPERATION 311.

In one embodiment, at STORE DATA REPRESENTING THE CATEGORIZED ONE OR MORE TAX CONFIGURATION TEMPLATES AND THEIR ASSOCIATED IDENTIFICATION DATA IN A TAX CONFIGURATION TEMPLATE DATABASE OPERATION 311 the tagged, identified, and/or categorized tax template data of ASSOCIATE IDENTIFICATION DATA WITH EACH OF THE ONE OR MORE TAX CONFIGURATION TEMPLATES AND USE THE IDENTIFICATION DATA TO CATEGORIZE EACH OF THE ONE OR MORE TAX CONFIGURATION TEMPLATES OPERATION 309 is stored/added to a tax template database, also referred to herein as a tax configuration template database, associated with the financial management system of PROVIDE INDIVIDUAL USERS OF A FINANCIAL MANAGEMENT SYSTEM THE CAPABILITY TO CUSTOMIZE A TAX CONFIGURATION USED BY THE FINANCIAL MANAGEMENT SYSTEM OPERATION 303.

In one embodiment, the tax template database associated with the financial management system of STORE DATA REPRESENTING THE CATEGORIZED ONE OR MORE TAX CONFIGURATION TEMPLATES AND THEIR ASSOCIATED IDENTIFICATION DATA IN A TAX CONFIGURATION TEMPLATE DATABASE OPERATION 311 includes all tax template data submitted by contributing individuals from one or more tax regions.

In one embodiment, once the tagged, identified, and/or categorized tax template data of ASSOCIATE IDENTIFICATION DATA WITH EACH OF THE ONE OR MORE TAX CONFIGURATION TEMPLATES AND USE THE IDENTIFICATION DATA TO CATEGORIZE EACH OF THE ONE OR MORE TAX CONFIGURATION TEMPLATES OPERATION 309 is stored/added to a tax template database associated with the financial management system of PROVIDE INDIVIDUAL USERS OF A FINANCIAL MANAGEMENT SYSTEM THE CAPABILITY TO CUSTOMIZE A TAX CONFIGURATION USED BY THE FINANCIAL MANAGEMENT SYSTEM OPERATION 303 at STORE DATA REPRESENTING THE CATEGORIZED ONE OR MORE TAX CONFIGURATION TEMPLATES AND THEIR ASSOCIATED IDENTIFICATION DATA IN A TAX CONFIGURATION TEMPLATE DATABASE OPERATION 311, process flow proceeds to PROVIDE A TEMPLATE SEEKING INDIVIDUAL ACCESS TO THE TAX CONFIGURATION TEMPLATE DATABASE AND OBTAIN TAX TEMPLATE REQUEST DATA FROM THE TEMPLATE SEEKING INDIVIDUAL OPERATION 313.

In one embodiment, at PROVIDE A TEMPLATE SEEKING INDIVIDUAL ACCESS TO THE TAX CONFIGURATION TEMPLATE DATABASE AND OBTAIN TAX TEMPLATE REQUEST DATA FROM THE TEMPLATE SEEKING INDIVIDUAL OPERATION 313 a template seeking individual using the financial management system of PROVIDE INDIVIDUAL USERS OF A FINANCIAL MANAGEMENT SYSTEM THE CAPABILITY TO CUSTOMIZE A TAX CONFIGURATION USED BY THE FINANCIAL MANAGEMENT SYSTEM OPERATION 303 that desires to implement a tax configuration optimized for their region, and/or business type, is provided access to the tax template database of STORE DATA REPRESENTING THE CATEGORIZED ONE OR MORE TAX CONFIGURATION TEMPLATES AND THEIR ASSOCIATED IDENTIFICATION DATA IN A TAX CONFIGURATION TEMPLATE DATABASE OPERATION 311 and submits tax template request data.

In one embodiment, at PROVIDE A TEMPLATE SEEKING INDIVIDUAL ACCESS TO THE TAX CONFIGURATION TEMPLATE DATABASE AND OBTAIN TAX TEMPLATE REQUEST DATA FROM THE TEMPLATE SEEKING INDIVIDUAL OPERATION 313 the template seeking individual is provided access to the tax template database, and/or submits tax template request data, via a template seeking computing system, such as any computing system discussed herein, and/or as known in the art/available at the time of filing, and/or as developed/made available after the time of filing.

In one embodiment, at PROVIDE A TEMPLATE SEEKING INDIVIDUAL ACCESS TO THE TAX CONFIGURATION TEMPLATE DATABASE AND OBTAIN TAX TEMPLATE REQUEST DATA FROM THE TEMPLATE SEEKING INDIVIDUAL OPERATION 313 the template seeking individual is provided access to the tax template database, and/or submits tax template request data, via one or more means for transferring data such as, but not limited to, providing the data through one or more network locations; e-mail; text message; POTS; or any other method, means, mechanism, process or procedure for transferring data discussed herein, and/or as known/available in the art at the time of filing, and/or as developed/made available after the time of filing.

In one embodiment, the tax template request data of PROVIDE A TEMPLATE SEEKING INDIVIDUAL ACCESS TO THE TAX CONFIGURATION TEMPLATE DATABASE AND OBTAIN TAX TEMPLATE REQUEST DATA FROM THE TEMPLATE SEEKING INDIVIDUAL OPERATION 313 includes data indicating the template seeking individual's desired search parameters, such as, but not limited to, any one or more of, the tax region; the type of tax, e.g., sales, side, purchase side, purchase reclaimable; the tax agencies involved, e.g., the agency name, filling frequency, financial year, reporting standard; the various tax rates, e.g., sale/purchase, percent rate, calculated on net amount or tax on tax; the business type, etc.

In one embodiment, once a template seeking individual using the financial management system of PROVIDE INDIVIDUAL USERS OF A FINANCIAL MANAGEMENT SYSTEM THE CAPABILITY TO CUSTOMIZE A TAX CONFIGURATION USED BY THE FINANCIAL MANAGEMENT SYSTEM OPERATION 303 that desires to implement a tax configuration optimized for their region, and/or business type, is provided access to the tax template database of STORE DATA REPRESENTING THE CATEGORIZED ONE OR MORE TAX CONFIGURATION TEMPLATES AND THEIR ASSOCIATED IDENTIFICATION DATA IN A TAX CONFIGURATION TEMPLATE DATABASE OPERATION 311 and submits tax template request data at PROVIDE A TEMPLATE SEEKING INDIVIDUAL ACCESS TO THE TAX CONFIGURATION TEMPLATE DATABASE AND OBTAIN TAX TEMPLATE REQUEST DATA FROM THE TEMPLATE SEEKING INDIVIDUAL OPERATION 313 process flow proceeds to SEARCH THE TAX CONFIGURATION TEMPLATE DATABASE USING THE TAX TEMPLATE REQUEST DATA TO IDENTIFY ONE OR MORE MATCHED TAX CONFIGURATION TEMPLATES THAT AT LEAST PARTIALLY MATCH THE TEMPLATE REQUEST DATA OPERATION 315.

In one embodiment, at SEARCH THE TAX CONFIGURATION TEMPLATE DATABASE USING THE TAX TEMPLATE REQUEST DATA TO IDENTIFY ONE OR MORE MATCHED TAX CONFIGURATION TEMPLATES THAT AT LEAST PARTIALLY MATCH THE TEMPLATE REQUEST DATA OPERATION 315 the tax template database of STORE DATA REPRESENTING THE CATEGORIZED ONE OR MORE TAX CONFIGURATION TEMPLATES AND THEIR ASSOCIATED IDENTIFICATION DATA IN A TAX CONFIGURATION TEMPLATE DATABASE OPERATION 311 is searched for tax configuration templates of TRANSFORM THE TAX TEMPLATE INPUT DATA FROM THE ONE OR MORE CONTRIBUTING INDIVIDUALS INTO ONE OR MORE TAX CONFIGURATION TEMPLATES FOR ONE OR MORE REGIONS AND/OR TYPES OF ACTIVITY OPERATION 307 matching, or most closely matching, the entered search parameters of the tax template request data of PROVIDE A TEMPLATE SEEKING INDIVIDUAL ACCESS TO THE TAX CONFIGURATION TEMPLATE DATABASE AND OBTAIN TAX TEMPLATE REQUEST DATA FROM THE TEMPLATE SEEKING INDIVIDUAL OPERATION 313.

In one embodiment, at SEARCH THE TAX CONFIGURATION TEMPLATE DATABASE USING THE TAX TEMPLATE REQUEST DATA TO IDENTIFY ONE OR MORE MATCHED TAX CONFIGURATION TEMPLATES THAT AT LEAST PARTIALLY MATCH THE TEMPLATE REQUEST DATA OPERATION 315 the tax template database is searched for one or more tax configuration templates matching, or most closely matching, the entered search parameters of the tax template request data under the direction of one or more processors, such as CPU 121 of FIG. 1, associated with one or more computing systems, such as process system 120 of FIG. 1.

Returning to FIG. 3, in one embodiment, at SEARCH THE TAX CONFIGURATION TEMPLATE DATABASE USING THE TAX TEMPLATE REQUEST DATA TO IDENTIFY ONE OR MORE MATCHED TAX CONFIGURATION TEMPLATES THAT AT LEAST PARTIALLY MATCH THE TEMPLATE REQUEST DATA OPERATION 315 one or more matched tax configuration templates, as represented by tax template data, matching, or most closely matching, the entered search parameters of the tax template request data are identified.

In one embodiment, at SEARCH THE TAX CONFIGURATION TEMPLATE DATABASE USING THE TAX TEMPLATE REQUEST DATA TO IDENTIFY ONE OR MORE MATCHED TAX CONFIGURATION TEMPLATES THAT AT LEAST PARTIALLY MATCH THE TEMPLATE REQUEST DATA OPERATION 315 tax template data representing the one or more matched tax configuration templates is then provided to the template seeking individual for review.

In one embodiment, at SEARCH THE TAX CONFIGURATION TEMPLATE DATABASE USING THE TAX TEMPLATE REQUEST DATA TO IDENTIFY ONE OR MORE MATCHED TAX CONFIGURATION TEMPLATES THAT AT LEAST PARTIALLY MATCH THE TEMPLATE REQUEST DATA OPERATION 315 tax template data representing the one or more matched tax configuration templates is provided to the template seeking individual for review via a template seeking computing system, such as any computing system discussed herein, and/or as known in the art/available at the time of filing, and/or as developed/made available after the time of filing.

In one embodiment, at SEARCH THE TAX CONFIGURATION TEMPLATE DATABASE USING THE TAX TEMPLATE REQUEST DATA TO IDENTIFY ONE OR MORE MATCHED TAX CONFIGURATION TEMPLATES THAT AT LEAST PARTIALLY MATCH THE TEMPLATE REQUEST DATA OPERATION 315 tax template data representing the one or more matched tax configuration templates is provided to the template seeking individual for review via one or more means for transferring data such as, but not limited to, providing the data through one or more network locations; e-mail; text message; POTS; or any other method, means, mechanism, process or procedure for transferring data discussed herein, and/or as known/available in the art at the time of filing, and/or as developed/made available after the time of filing.

In one embodiment, once the tax template database is searched for one or more tax configuration templates matching, or most closely matching, the entered search parameters of the tax template request data, and the matched tax configuration templates are provided to the template seeking individual at SEARCH THE TAX CONFIGURATION TEMPLATE DATABASE USING THE TAX TEMPLATE REQUEST DATA TO IDENTIFY ONE OR MORE MATCHED TAX CONFIGURATION TEMPLATES THAT AT LEAST PARTIALLY MATCH THE TEMPLATE REQUEST DATA OPERATION 315, process flow proceeds to THE TEMPLATE SEEKING INDIVIDUAL SELECTS ONE OF THE ONE OR MORE MATCHED TAX CONFIGURATION TEMPLATES OPERATION 317.

In one embodiment, at THE TEMPLATE SEEKING INDIVIDUAL SELECTS ONE OF THE ONE OR MORE MATCHED TAX CONFIGURATION TEMPLATES OPERATION 317 the template seeking individual of PROVIDE A TEMPLATE SEEKING INDIVIDUAL ACCESS TO THE TAX CONFIGURATION TEMPLATE DATABASE AND OBTAIN TAX TEMPLATE REQUEST DATA FROM THE TEMPLATE SEEKING INDIVIDUAL OPERATION 313 selects a tax configuration template of the one or more the tax configuration templates of SEARCH THE TAX CONFIGURATION TEMPLATE DATABASE USING THE TAX TEMPLATE REQUEST DATA TO IDENTIFY ONE OR MORE MATCHED TAX CONFIGURATION TEMPLATES THAT AT LEAST PARTIALLY MATCH THE TEMPLATE REQUEST DATA OPERATION 315, matching, or most closely matching, the template seeking individual's needs.

In one embodiment, at THE TEMPLATE SEEKING INDIVIDUAL SELECTS ONE OF THE ONE OR MORE MATCHED TAX CONFIGURATION TEMPLATES OPERATION 317 the template seeking individual selects a tax configuration template matching, or most closely matching, the template seeking individual's needs via a template seeking computing system, such as any computing system discussed herein, and/or as known in the art/available at the time of filing, and/or as developed/made available after the time of filing.

In one embodiment, at THE TEMPLATE SEEKING INDIVIDUAL SELECTS ONE OF THE ONE OR MORE MATCHED TAX CONFIGURATION TEMPLATES OPERATION 317 the template seeking individual selects a tax configuration template matching, or most closely matching, the template seeking individual's needs via one or more means for transferring data such as, but not limited to, providing the data through one or more network locations; e-mail; text message; POTS; or any other method, means, mechanism, process or procedure for transferring data discussed herein, and/or as known/available in the art at the time of filing, and/or as developed/made available after the time of filing.

In one embodiment, once the template seeking individual selects a tax configuration template matching, or most closely matching, the template seeking individual's needs at THE TEMPLATE SEEKING INDIVIDUAL SELECTS ONE OF THE ONE OR MORE MATCHED TAX CONFIGURATION TEMPLATES OPERATION 317, process flow proceeds to USE THE SELECTED MATCHED TAX CONFIGURATION TEMPLATE TO CONFIGURE THE TAX CONFIGURATION USED WITH THE TEMPLATE SEEKING INDIVIDUAL'S IMPLEMENTATION OF THE FINANCIAL MANAGEMENT SYSTEM OPERATION 319.

In one embodiment, at USE THE SELECTED MATCHED TAX CONFIGURATION TEMPLATE TO CONFIGURE THE TAX CONFIGURATION USED WITH THE TEMPLATE SEEKING INDIVIDUAL'S IMPLEMENTATION OF THE FINANCIAL MANAGEMENT SYSTEM OPERATION 319 the selected tax configuration template of THE TEMPLATE SEEKING INDIVIDUAL SELECTS ONE OF THE ONE OR MORE MATCHED TAX CONFIGURATION TEMPLATES OPERATION 317 is imported to the template seeking individual's template seeking computing system where the matched tax template data is used to configure the template seeking individual's financial management system implementation in accordance with the matched tax configuration template.

In one embodiment, at USE THE SELECTED MATCHED TAX CONFIGURATION TEMPLATE TO CONFIGURE THE TAX CONFIGURATION USED WITH THE TEMPLATE SEEKING INDIVIDUAL'S IMPLEMENTATION OF THE FINANCIAL MANAGEMENT SYSTEM OPERATION 319 the selected tax configuration template of THE TEMPLATE SEEKING INDIVIDUAL SELECTS ONE OF THE ONE OR MORE MATCHED TAX CONFIGURATION TEMPLATES OPERATION 317 is imported to the template seeking individual's template seeking computing system via one or more means for transferring data such as, but not limited to, providing the data through one or more network locations; e-mail; text message; POTS; or any other method, means, mechanism, process or procedure for transferring data discussed herein, and/or as known/available in the art at the time of filing, and/or as developed/made available after the time of filing.

In one embodiment, at USE THE SELECTED MATCHED TAX CONFIGURATION TEMPLATE TO CONFIGURE THE TAX CONFIGURATION USED WITH THE TEMPLATE SEEKING INDIVIDUAL'S IMPLEMENTATION OF THE FINANCIAL MANAGEMENT SYSTEM OPERATION 319 the selected tax configuration template is used to configure the template seeking individual's financial management system implementation in accordance with the matched tax configuration template under the direction of one or more processors, such as CPUs 101A, 101B, through 101N, and 121 of FIG. 1, associated with one or more computing systems, such as contributor systems 100A, 100B, through 100N and/or process system 120 of FIG. 1.

Returning to FIG. 3, in one embodiment, at USE THE SELECTED MATCHED TAX CONFIGURATION TEMPLATE TO CONFIGURE THE TAX CONFIGURATION USED WITH THE TEMPLATE SEEKING INDIVIDUAL'S IMPLEMENTATION OF THE FINANCIAL MANAGEMENT SYSTEM OPERATION 319 template seeking individuals are provided the capability to rate the tax template data provided at THE TEMPLATE SEEKING INDIVIDUAL SELECTS ONE OF THE ONE OR MORE MATCHED TAX CONFIGURATION TEMPLATES OPERATION 317.

In one embodiment, at USE THE SELECTED MATCHED TAX CONFIGURATION TEMPLATE TO CONFIGURE THE TAX CONFIGURATION USED WITH THE TEMPLATE SEEKING INDIVIDUAL'S IMPLEMENTATION OF THE FINANCIAL MANAGEMENT SYSTEM OPERATION 319 one or more forms of compensation are provided to the contributing individuals of OBTAIN TAX TEMPLATE INPUT DATA FROM ONE OR MORE CONTRIBUTING INDIVIDUALS REPRESENTING THE CONTRIBUTING INDIVIDUALS' REGIONAL AND/OR ACTIVITY-BASED CUSTOMIZATIONS OF THE TAX CONFIGURATION USED WITH THE FINANCIAL MANAGEMENT SYSTEM OPERATION 305 who are the creators of tax configuration templates that are widely used, and/or are highly rated.

In one embodiment, once the selected tax configuration template of THE TEMPLATE SEEKING INDIVIDUAL SELECTS ONE OF THE ONE OR MORE MATCHED TAX CONFIGURATION TEMPLATES OPERATION 317 is imported to the template seeking individual's template seeking computing system and the matched tax template data is used to configure the template seeking individual's financial management system implementation in accordance with the matched tax configuration template at USE THE SELECTED MATCHED TAX CONFIGURATION TEMPLATE TO CONFIGURE THE TAX CONFIGURATION USED WITH THE TEMPLATE SEEKING INDIVIDUAL'S IMPLEMENTATION OF THE FINANCIAL MANAGEMENT SYSTEM OPERATION 319, process flow proceeds to EXIT OPERATION 330.

In one embodiment, at EXIT OPERATION 330, process 300 for creating tax configuration templates is exited to await new data.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

Using process 300 for creating tax configuration templates discussed above, the tax configuration of a financial management system is modified for a specific region and/or business type by individual users of the financial management system and the resulting tax configuration templates are shared. Consequently, using process 300 for creating tax configuration templates, region specific versions of financial management systems are created in an efficient and resource conserving manner. The significant cost savings resulting from the implementation of process 300 for creating tax configuration templates can then be passed on to the user/customer.

As discussed in more detail above, using the above embodiments, with little or no modification and/or input, there is considerable flexibility, adaptability, and opportunity for customization to meet the specific needs of various parties under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

1-10. (canceled)

11. A computer program product for creating tax configuration templates comprising:
a nontransitory computer readable medium;
and computer program code, encoded on the computer readable medium, comprising computer readable instructions which, when executed via any set of one or more processors, perform the following:
creating, by a first contributing individual, a first tax configuration used with a financial management system, the tax configuration consisting of a sharable first portion and a nonsharable second portion, the first and second portions being determined by the contributing individual;
obtaining tax template input data from one or more contributing individuals who use the financial management system, the tax template input data representing regional modifications made by the contributing individuals to a tax configuration used with the financial management system, the tax template input data including the sharable first portion of the first tax configuration created by the first individual;
transforming at least part of the tax template input data into tax template data representing one or more tax configuration templates categorized according to the region associated with the tax template input data;
storing the categorized tax template data representing one or more tax configuration templates in a tax configuration template database;
providing a template seeking individual access to the tax configuration template database; and
providing the template seeking individual the ability to select a desired tax configuration template and import the tax template data representing the selected tax configuration template for use with the template seeking individuals' implementation of the financial management system.

12. The computer program product for creating tax configuration templates of claim 11 wherein the financial management system is a small business financial management system.

13. The computer program product for creating tax configuration templates of claim 11 wherein the contributing individual is a business owner or business employee who uses the financial management system.

14. The computer program product for creating tax configuration templates of claim 11 wherein the contributing individual is an accounting professional requested by the provider of the financial management system to provide regionalized tax template input data.

15. The computer program product for creating tax configuration templates of claim 11 wherein transforming at least part of the tax template input data into tax template data representing one or more tax configuration templates includes processing the tax template input data to remove any data identifying the contributing individual.

16. The computer program product for creating tax configuration templates of claim 11 wherein the at least part of the tax template input data that is transformed into tax template data representing one or more tax configuration templates is designated by the contributing individual.

17. The computer program product for creating tax configuration templates of claim 11 wherein the one or more tax configuration templates are categorized according to the region associated with the tax template input data and the type of business activity associated with the contributing individuals.

18. The computer program product for creating tax configuration templates of claim 11 wherein the one or more tax configuration templates are categorized according to the region associated with the tax template input data and type of tax associated with the tax configuration templates.

19. The computer program product for creating tax configuration templates of claim 11 wherein the one or more tax configuration templates are categorized according to the region associated with the tax template input data and contributor tax configuration template identification data obtained from the contributing individual.

20. The computer program product for creating tax configuration templates of claim 11 wherein the tax template data representing one or more tax configuration templates is categorized according to the region associated with the tax template input data and system tax configuration template identification data obtained by processing the tax template input data.

21. A system for creating tax configuration templates comprising:
at least one processor; and
at least one memory coupled to the at least one processor, the at least one memory having stored therein instructions which when executed by any set of the one or more processors, perform a process for creating tax configuration templates, the process for creating tax configuration templates including:
creating, by a first contributing individual, a first tax configuration used with a financial management system, the tax configuration consisting of a sharable first portion and a nonsharable second portion, the first and second portions being determined by the contributing individual;
obtaining tax template input data from one or more contributing individuals who use the financial management system, the tax template input data representing regional modifications made by the contributing individuals to a tax configuration used with the financial management system, the tax template input data including the sharable first portion of the first tax configuration created by the first individual;
transforming at least part of the tax template input data into tax template data representing one or more tax configuration templates categorized according to the region associated with the tax template input data;
storing the categorized tax template data representing one or more tax configuration templates in a tax configuration template database;
providing a template seeking individual access to the tax configuration template database; and
providing the template seeking individual the ability to select a desired tax configuration template and import the tax template data representing the selected tax configuration template for use with the template seeking individuals' implementation of the financial management system.

22. The system for creating tax configuration templates of claim 21 wherein the financial management system is a small business financial management system.

23. The system for creating tax configuration templates of claim 21 wherein the contributing individual is a business owner or business employee who uses the financial management system.

24. The system for creating tax configuration templates of claim 21 wherein the contributing individual is an accounting professional requested by the provider of the financial management system to provide regionalized tax template input data.

25. The system for creating tax configuration templates of claim 21 wherein transforming at least part of the tax template input data into tax template data representing one or more tax configuration templates includes processing the tax template input data to remove any data identifying the contributing individual.

26. The system for creating tax configuration templates of claim 21 wherein the at least part of the tax template input data that is transformed into tax template data representing one or more tax configuration templates is designated by the contributing individual.

27. The system for creating tax configuration templates of claim 21 wherein the one or more tax configuration templates are categorized according to the region associated with the tax template input data and the type of business activity associated with the contributing individuals.

28. The system for creating tax configuration templates of claim 21 wherein the one or more tax configuration templates are categorized according to the region associated with the tax template input data and type of tax associated with the tax configuration templates.

29. The system for creating tax configuration templates of claim 21 wherein the one or more tax configuration templates are categorized according to the region associated with the tax template input data and contributor tax configuration template identification data obtained from the contributing individual.

30. The system for creating tax configuration templates of claim 21 wherein the tax template data representing one or more tax configuration templates is categorized according to the region associated with the tax template input data and system tax configuration template identification data obtained by processing the tax template input data.
